(19) United States
(12) Patent Application Publication
(10) Pub. No.: US 2023/0198979 A1
(43) Pub. Date: Jun. 22, 2023

(54) ROUTING OF SESSION TOKENS IN A DISTRIBUTED EXTENSIBLE SYSTEM

(71) Applicant: VMware, Inc., Palo Alto, CA (US)

(72) Inventors: Plamen Dimitrov, Sofia (BG); Tony Ganchev, Sofia (BG)

(73) Assignee: VMware, Inc., Palo Alto, CA (US)

(21) Appl. No.: 18/082,188

(22) Filed: Dec. 15, 2022

Related U.S. Application Data
(60) Provisional application No. 63/290,441, filed on Dec. 16, 2021.

(51) Int. Cl. H04L 9/40

(52) U.S. Cl. CPC H04L 63/083

(57) ABSTRACT

The present disclosure relates to routing of session tokens in a distributed extensible system. One method includes generating a session token by a first node in a distributed extensible system responsive to a login to a user interface of the distributed extensible system loaded by the first node, returning the session token to the user interface by the first node, pushing the session token from the user interface to a plugin server configured to trust a second node of the distributed extensible system, receiving a request at the second node to perform a particular action on the distributed extensible system, wherein the request is made by a plugin installed on the second node and includes the session token, routing the request to the first node based on an identifier in the session token, and performing the particular action on the extensible system responsive to verifying the session token by the first node.

### BACKGROUND

A data center is a facility that houses servers, data storage devices, and/or other associated components such as backup power supplies, redundant data communications connections, environmental controls such as air conditioning and/or fire suppression, and/or various security systems. A data center may be maintained by an information technology (IT) service provider. An enterprise may utilize data storage and/or data processing services from the provider in order to run applications that handle the enterprises' core business and operational data. The applications may be proprietary and used exclusively by the enterprise or made available through a network for anyone to access and use.

Virtual computing instances (VCIs), such as virtual machines and containers, have been introduced to lower data center capital investment in facilities and operational expenses and reduce energy consumption. A VCI is a software implementation of a computer that executes application software analogously to a physical computer. VCIs have the advantage of not being bound to physical resources, which allows VCIs to be moved around and scaled to meet changing demands of an enterprise without affecting the use of the enterprise's applications. In a software-defined data center, storage resources may be allocated to VCIs in various ways, such as through network attached storage (NAS), a storage area network (SAN) such as fiber channel and/or Internet small computer system interface (iSCSI), a virtual SAN, and/or raw device mappings, among others.

### BRIEF DESCRIPTION OF THE DRAWINGS

FIG. 1 is a block diagram illustrating an extensible system with two nodes in accordance with one or more embodiments of the present disclosure.

FIG. 2 is a block diagram illustrating a system in accordance with one or more embodiments of the present disclosure.

FIG. 3 is a block diagram illustrating reverse proxy configuration for session token routing in accordance with one or more embodiments of the present disclosure.

FIG. 4 is a block diagram illustrating a workflow including the obtainment of a session token by a plugin and session token routing in accordance with one or more embodiments of the present disclosure.

FIG. 5 is a diagram of a cluster and a system for routing of session tokens in a distributed extensible system according to one or more embodiments of the present disclosure.

### DETAILED DESCRIPTION

The term “virtual computing instance” (VCI) refers generally to an isolated user space instance, which can be executed within a virtualized environment. Other technologies aside from hardware virtualization can provide isolated user space instances, also referred to as data compute nodes (or simply as “compute nodes” and/or “nodes.” Data compute nodes may include non-virtualized physical hosts, VCIs, containers that run on top of a host operating system without a hypervisor or separate operating system, and/or hypervisor kernel network interface modules, among others. Hypervisor kernel network interface modules are non-VCI data compute nodes that include a network stack with a hypervisor kernel network interface and receive/transmit threads.

VCIs, in some embodiments, operate with their own guest operating systems on a host using resources of the host virtualized by virtualization software (e.g., a hypervisor, virtual machine monitor, etc.). The tenant (i.e., the owner of the VCI) can choose which applications to operate on top of the guest operating system. Some containers, on the other hand, are constructs that run on top of a host operating system without the need for a hypervisor or separate guest operating system. The host operating system can use name spaces to isolate the containers from each other and therefore can provide operating-system level segregation of the different groups of applications that operate within different containers. This segregation is akin to the VCI segregation that may be offered in hypervisor-virtualized environments that virtualize system hardware, and thus can be viewed as a form of virtualization that isolates different groups of applications that operate in different containers. Such containers may be more lightweight than VCIs.

While the specification refers generally to VCIs, the examples given could be any type of data compute node, including physical hosts, VCIs, non-VCI containers, and hypervisor kernel network interface modules. Embodiments of the present disclosure can include combinations of different types of data compute nodes.

As used herein, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

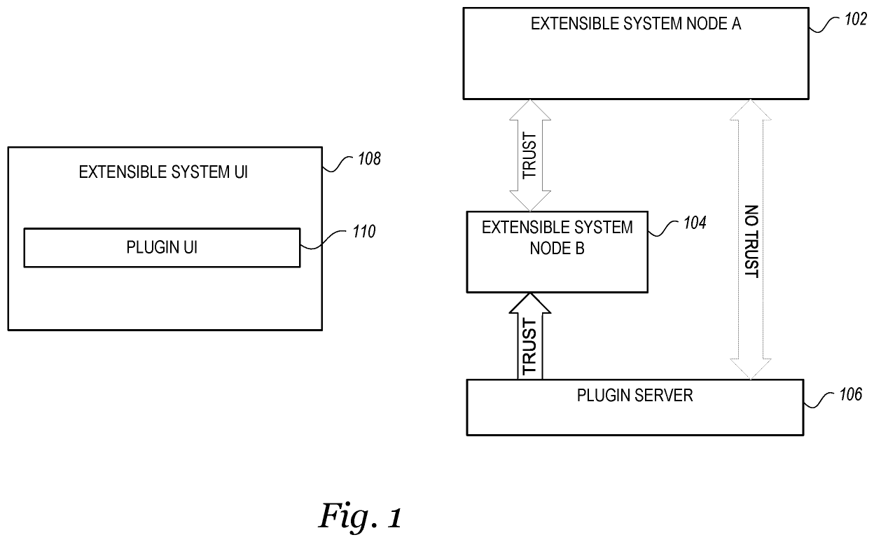

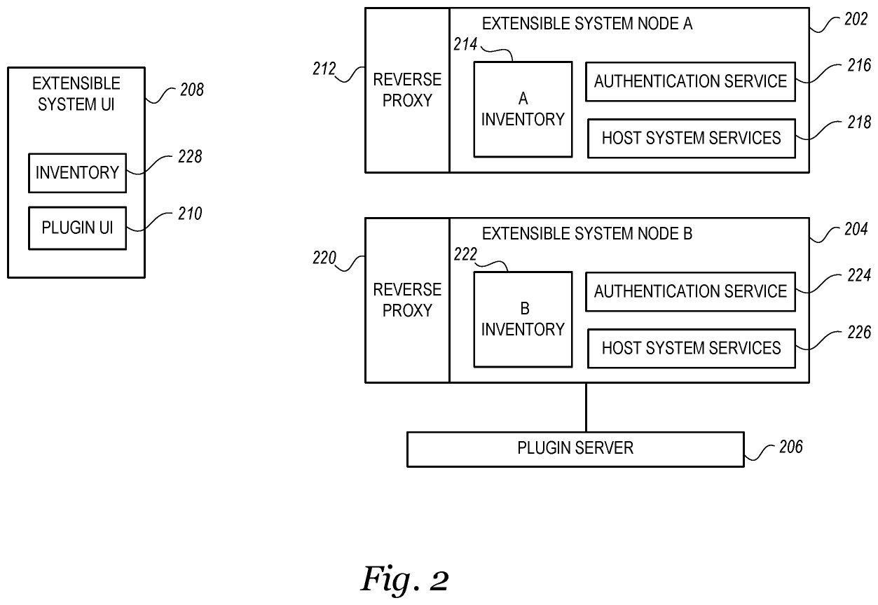

The figures herein follow a numbering convention in which the first digit or digits correspond to the drawing figure number and the remaining digits identify an element or component in the drawing. Similar elements or components between different figures may be identified by the use of similar digits. For example, 106 may reference element “06” in FIG. 1, and a similar element may be referenced as 206 in FIG. 2. Analogous elements within a Figure may be referenced with a hyphen and extra numeral or letter. Such analogous elements may be generally referenced without the hyphen and extra numeral or letter. For example, elements 538-1, 538-2, and 538-N in FIG. 1 may be collectively referenced as 538. As used herein, the designator “N,” particularly with respect to reference numerals in the drawings, indicates that a number of the particular feature so designated can be included. As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate certain embodiments of the present invention and should not be taken in a limiting sense.

A multi-node distributed extensible system can provide a consolidated user interface for its users. The system supports session token-based authentication where each node may serve as the issuer of such tokens, but those tokens are not shared amongst the nodes. Plugins integrating into such an extensible system may receive a session token issued from any of the nodes in the system. To authenticate to the extensible system the plugin would require knowledge of the issuer node of the token since the tokens are specific to the separate nodes.

Embodiments of the present disclosure address the problem of session token-based authentication in an extensible system where the nodes do not share state. Plugins integrating into such extensible systems can use the session token they possess to authenticate to the extensible system by calling any of the nodes comprising the system. Embodiments herein can be used as part of a remote plugin architecture (e.g., vCenter remote plugin architecture). The distributed extensible systems can be federated multi-server deployments utilizing an Enhanced or Hybrid Linked Mode, and the plugins can be vSphere UI remote plugins, for instance.

An extensible system, as referred to herein is a piece of software, the functionality of which can be enhanced by installing additional plugins without updating the whole system to a new version. For example, an extensible system can be vCenter Server. Extensible systems of this type traditionally have at least the following components: an extensible system UI, an authentication service, host system services, and a reverse proxy.

The extensible system UI can run on the user device and may be a web browser. The extensible system UI can provide an extension point for plugin UIs. Within the context of the example of vSphere, the extensible system UI is the frontend of the vSphere Client. The authentication service is a service that can handle authentication requests from users. The authentication service is responsible for providing session tokens to the Extensible System UI when users use the UI to access the Extensible System. The authentication service may run in a datacenter or in the cloud. Host system services provide the business logic of the extensible system. Host system services can run in a datacenter or in the cloud. A reverse proxy is a proxy server within the extensible system deployment and other services running in the datacenter or in the cloud. To the client device it appears as if communication is occurring with a single server. The proxy distributes all inbound network traffic to the various services within the extensible system. The proxy can run in a datacenter or in the cloud. The proxy server can run on the same physical or virtual appliance as the services it hides or can run on a dedicated appliance. In the case of the example of vSphere, the proxy is based on Envoy and runs on each vCenter Server Appliance. A load balancer is a type of proxy server that redirects traffic to one out of multiple equivalent upstream application servers based on a specific policy (e.g., round robin, session hash (also known as sticky sessions), etc.). The load balancer usually is not running on the same physical or virtual appliance as the upstream servers because a load balancer usually is used to provide scalability to the system rather than security. vSphere, for example, does not include a load balancer as part of its architecture.

A distributed extensible system is a specific type of extensible systems where the backend is split into multiple servers providing similar functionality. The aim of such a system is to achieve a better scale or guarantee certain service-level agreements (SLAs). When reference is made herein to an “extensible system,” it is to be understood that a distributed extensible system is intended. While there may be multiple deployment topologies for such a system, the present disclosure may refer to a distributed extensible system with the following characteristics: first, each server node of the system manages its own resources. In the context of the example of vSphere, each vCenter has its own virtual infrastructure inventory. The individual vCenters are aware of each other but do not share state. vSphere supports three topologies that support this model: Enhanced Linked Mode, Hybrid Linked Mode, and Multi-SDDC. Second, there is established trust between all comprising server nodes. Third, the Extensible System UI is available on each individual extensible system server node but in contrast to the server-side, these UI instances all provide a consolidated view (single pane of glass) of the resources managed by all nodes in the system. Within the context of the example of vSphere, this is handled in the frontend of the vSphere Client.

A plugin is a component that is installed independently on one or more of the nodes in a (distributed) extensible system. In some cases, the plugin may not bring any value without integration into the extensible system. Examples of plugins include Veeam Backup and Restore for vSphere, and vSphere Update Manager. Plugins can include two major parts, a plugin UI, and a plugin server. The plugin UI is a portion of the plugin running on a user device, and may be a web browser, in some embodiments. The plugin UI integrates into the extension points provided by the Extensible System UI. The plugin server is a server component running in a datacenter and/or cloud. The plugin server communicates (e.g., authenticates) with (e.g., only with) the nodes in the extensible system that it is installed on, as it may generally not trust the other nodes.

An interactive user, as used herein, refers to the identity of an actual employee and/or member of an organization and/or company interacting with the extensible system. A session token is a secret piece of data identifying an authenticated conversation between a client device and a server on behalf of a specific user. The client device receives a valid session token for a user because of that user entering correct credentials into the extensible system UI. Session tokens typically do not carry any security information (in contrast with a claim-based security model), so any authorization decision is made by the session token issuer. Examples include any classic cookie-based server session and Kerberos, for instance. A session token issuer is a component responsible for issuing session tokens based on user-provided valid credentials.

Trust is an aspect of a distributed system where a server (server A) is certain about the authenticity of another server (server B). In other words, server A trusts server B, and therefore can pass sensitive information to server B. For example, when a browser that loaded Amazon is sending the user's credentials to the server at https://amazon.com/. Trust is guaranteed through public key infrastructure (PKI) by validating https://amazon.com/'s fully-trusted TLS/SSL certificate. This example demonstrates a one-way trust. Other cases where the browser also presents a certificate, such as e-banking systems, are examples of two-way trust. In the example of vSphere, two-way trust is set up between two vCenters through a shared trust-store, which is a service storing all of the vCenter's TLS/SSL certificates.

FIG. 1 is a block diagram illustrating an extensible system with two nodes in accordance with one or more embodiments of the present disclosure. The system illustrated in FIG. 1 includes extensible system node A 102 and extensible system node B 104 (sometimes referred to herein simply as “node A 102” and “node B 104,” respectively). As illustrated in FIG. 1, there is mutual trust between node A 102 and node B 104. Additionally, there is a plugin server 106 (sometimes referred to herein simply as “plugin 106”) installed on node B 104. Stated differently the plugin 106 is configured to trust node B 104. In this example, the plugin 106 is not configured to trust node A 102.

The extensible system includes an extensible system UI 108 (“UI 108”). The UI 108 can be loaded from either or both node A 102 and node B 104 to show the inventory of both nodes. Accordingly, the plugin frontend 110 (sometimes referred to herein as “plugin UI 110”) may be passed session tokens issued by both node A 102 and node B 104 through the UI 108. However, an issue occurs when the UI 108 is loaded from node A 102 and the plugin 106 seeks to authenticate to the extensible system. In previous approaches, the plugin frontend 110 would push a session token issued by node A 102 to the plugin server 106. The plugin server 106 would try to use the session token and call node B 104 to authenticate, but the authentication request would fail as node B 104 does not recognize the session token.

Embodiments herein can extend the trust the plugin server 106 has with node B 104 to the whole extensible system (or, more specifically, node A 102 in the above example) if it already trusts node A 102. Embodiments of the present disclosure can address the problem outlined above in the context of a few architectural constraints: the nodes of the extensible system are not equivalent (each node maintains its own state and/or managed entities and cannot manipulate another node's inventory and/or managed entities, the extensible system does not support session sharing across the different nodes or a single sign-on solution based on claims-based security: each node of the extensible system issues its own session tokens, plugin UIs are able to authenticate with session tokens issued by a node of the extensible system the plugin server does not trust, there is no shared trust-store and/or PKI infrastructure that would allow a plugin server to automatically trust all nodes of the extensible system, and there is no discovery service to even allow the plugin servers to lookup the endpoint URLs of the different nodes of the extensible system. It is noted that given these constraints, a solution that uses a sticky session with a central load balancer (LB) would not apply as the nodes the LB would be proxying are not equivalent.

FIG. 2 is a block diagram illustrating a system in accordance with one or more embodiments of the present disclosure. As shown in FIG. 2, the system includes node A 202 and node B 204. Additionally, the system includes a plugin 206 installed on node B 204 of the extensible system. An interactive user is exploring the distributed extensible system by opening the Extensible System UI 208 on node A 202 on a suitable user device. The user sees a consolidated view (illustrated as “inventory 228”) of the whole system, which includes entities managed by both nodes as well as the plugin UI 210 installed on node B 204. Stated differently, the inventory 228 is a consolidation of the inventory 214 of node A 202 and the inventory 222 of node B 204.

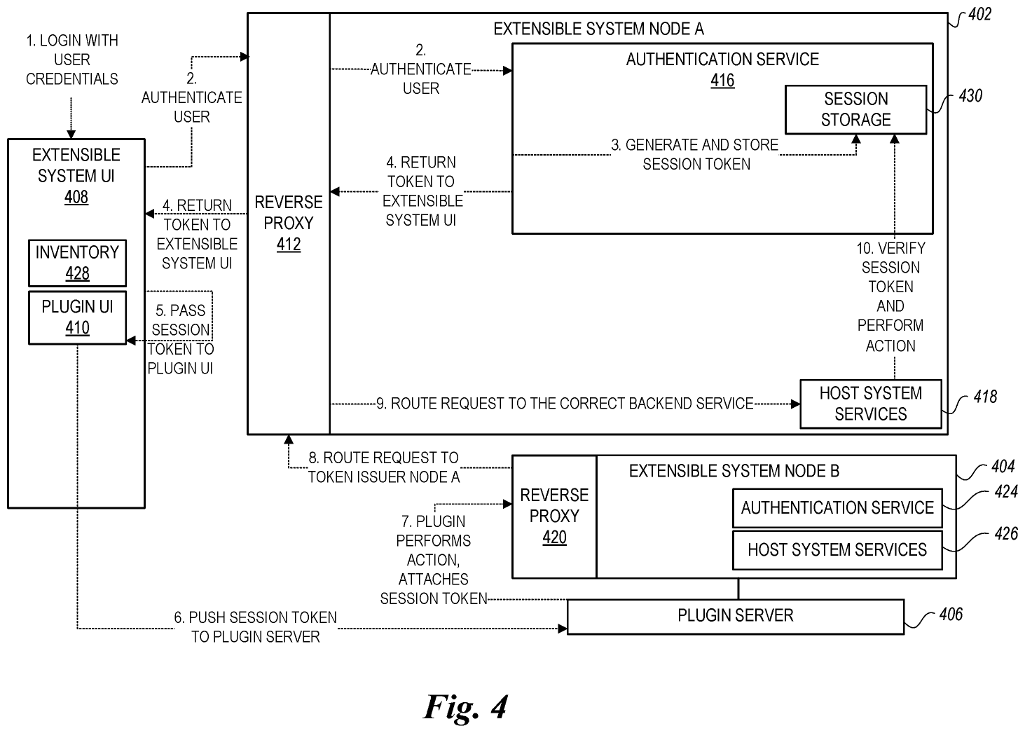

Embodiments herein include the obtainment of a session token by a plugin 206. As will be discussed in further detail below in connection with FIG. 4, a user can enter login credentials in the Extensible System UI 208. An authentication request is sent to the authentication service 216 on node A 202 as this is the node the UI 208 was loaded from. If authentication was successful, the authentication service 216 on node A 202 generates a unique session token. The token is stored on extensible system node A 202 (e.g., in memory) and is not shared with the other nodes (e.g., node B 204). The token is then returned to the extensible system UI 208. Later, the plugin UI 210 can also retrieve it in-process from the extensible system UI 208 when needed and push it to the plugin server 206. At this point, the plugin has a valid session token and seeks to authenticate to the distributed extensible system. The plugin seeks to communicate with the node it is installed on (node B 204), but it has a token issued by node A 202. The session token that the plugin receives encodes the session token issuer. In the above example, the token may be represented as: issuer:nodeA,uniqueValue:<random_bytes>. The token is an opaque blob to the plugin (e.g., the plugin does not need to understand the token format).

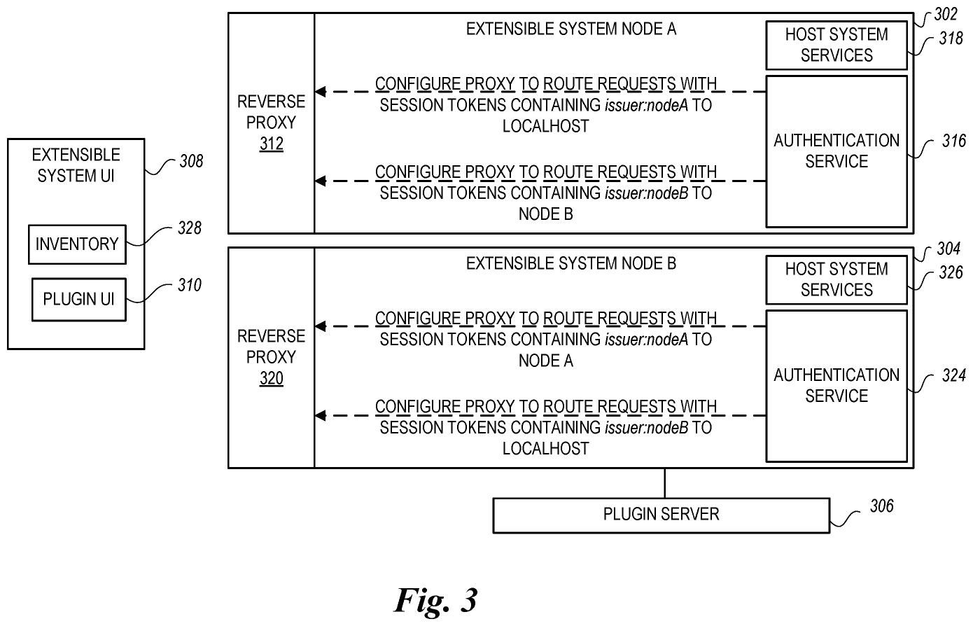

FIG. 3 is a block diagram illustrating reverse proxy configuration for session token routing in accordance with one or more embodiments of the present disclosure. Requests to the extensible system pass through the reverse proxy facade in front of it. The reverse proxy on each node is dynamically configured by the authentication service to recognize and route plugin requests to the node that issued the session token attached in the request. The recognition can be made based on an identifier of the node that issued the token. As illustrated in FIG. 3, the authentication service 316 of node A 302 can configure the reverse proxy 312 to route requests with session tokens containing issuer:nodeA to localhost (e.g., node A 302), and route requests with session tokens containing issuer:nodeB to node B 304. Similarly, the authentication service 324 of node B 304 can configure the reverse proxy 320 to route requests with session tokens containing issuer:nodeA to node A 302, and route requests with session tokens containing issuer:nodeB to local host (e.g., node B 304).

FIG. 4 is a block diagram illustrating session token routing in accordance with one or more embodiments of the present disclosure. As previously discussed, at (1) a user can enter login credentials in the Extensible System UI 408. At (2) an authentication request is sent to the authentication service 416 on node A 402 as this is the node the UI 408 was loaded from. If authentication was successful, the authentication service 416 on node A 402 generates and stores a unique session token at (3). The token is not shared with node B 404. The token is then, at (4), returned to the extensible system UI 408. Later, the plugin UI 410 can also retrieve it in-process from the extensible system UI 408 when needed (5) and push it (6) to the plugin server 406. At this point, the plugin has a valid session token and seeks to authenticate to the distributed extensible system. The plugin seeks to communicate with the node it is installed on (node B 404), but it has a token issued by node A 402. The session token that the plugin receives encodes the session token issuer. As previously discussed, in the above example, the token may be represented as: issuer:nodeA,uniqueValue:<random_bytes>.

When the plugin seeks to perform an action on the extensible system it may do so by calling any node in the environment by attaching the session token in the request. In the example illustrated in FIG. 4, this is likely to be node B 404 since this is where the plugin has been installed (7). Once the request reaches the reverse proxy 420 on node B 404, the proxy 420 inspects the session token issuer (encoded within the token) and routes (8) the request to the issuer node (node A 402). The reverse proxy 412 on node A 402 determines that the token is issued by the local node (node A 402) and distributes the request (9) to the correct backend service 418 (illustrated in FIG. 4 as “host system services 418”). The backend service 418 verifies the session token in the request against the local Authentication Service 416 and proceeds with the operation (10).

Previous approaches include replicating the session between the nodes. However, these approaches require sync infrastructure between nodes that does not work well with certain architectures (e.g., vSphere architecture). Some previous approaches store the sessions in a centralized database that all nodes write to and read from. However, these approaches require an independent database that each node connects to and does not work well with certain infrastructures (e.g., vSphere infrastructure). Other approaches implement a single facade (e.g., load balancer) in front of the node federation that implements sticky sessions, wherein all requests go through this facade, and requests belonging to the same session would go to the same node. Plugin servers need to “trust” the load balancer instead of the specific nodes of the system thus complicating their architecture. This is inapplicable in certain circumstances (e.g., with vSphere) since with sticky sessions the load balancer picks one of the nodes at random for a new session and uses this node for every subsequent call in the same session. In the present case, however, a specific node is selected based on its relationship with the plugin server, and this is outside the scope of sticky-session load balancing solutions.

In accordance with the present disclosure, session tokens issued by each node carry their routing (issuer) information. In contrast, systems based on sticky sessions usually keep a routing table of all sessions and their destination nodes which requires that forwarding the requests to the right node of the distributed system always goes through the same proxy server. In accordance with the present disclosure, distributed nodes issue session tokens such that the tokens can be “understood” and used by the proxy servers. In contrast, sticky session-based solutions treat tokens as completely opaque. In accordance with the present disclosure, the reverse proxy component on each individual node can route session tokens between the nodes in a distributed multi-node environment. As established above, alternative solutions use a central load-balancing proxy.

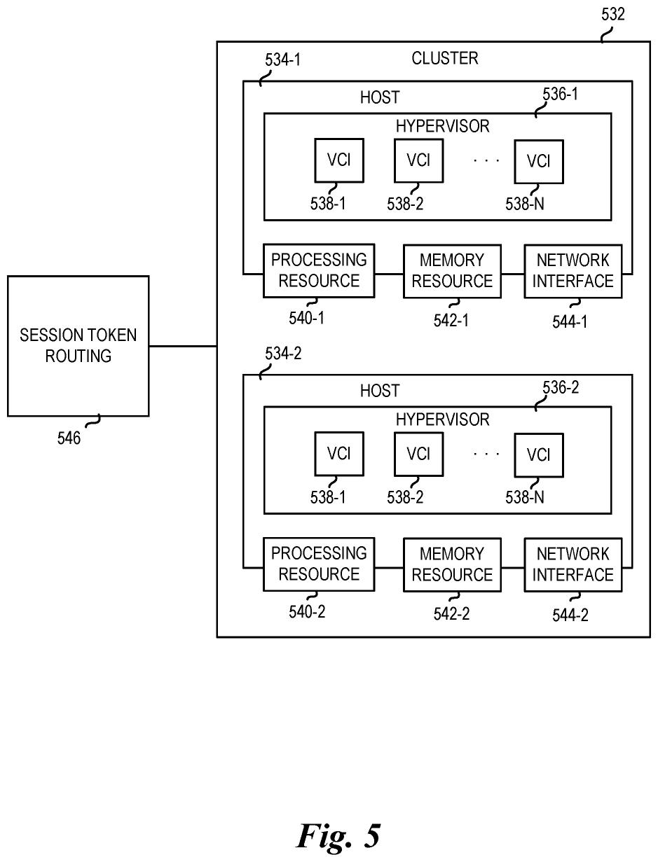

FIG. 5 is a diagram of a cluster and a system for routing of session tokens in a distributed extensible system according to one or more embodiments of the present disclosure. The system can include a cluster 532 in communication with a session token routing system 546. The cluster 532 can include a first host 534-1 with processing resources 540-1 (e.g., a number of processors), memory resources 542-1, and/or a network interface 544-1. Similarly, the cluster 532 can include a second host 534-2 with processing resources 540-2, memory resources 542-2, and/or a network interface 544-2. Though two hosts are shown in FIG. 1 for purposes of illustration, embodiments of the present disclosure are not limited to a particular number of hosts. For purposes of clarity, the first host 534-1 and/or the second host 534-2 (and/or additional hosts not illustrated in FIG. 1) may be generally referred to as “host 534.” Similarly, reference is made to “hypervisor 536,” “VCI 538,” “processing resources 540,” memory resources 542,” and “network interface 544,” and such usage is not to be taken in a limiting sense.

The host 534 can be included in a software-defined data center. A software-defined data center can extend virtualization concepts such as abstraction, pooling, and automation to data center resources and services to provide information technology as a service (ITaaS). In a software-defined data center, infrastructure, such as networking, processing, and security, can be virtualized and delivered as a service. A software-defined data center can include software-defined networking and/or software-defined storage. In some embodiments, components of a software-defined data center can be provisioned, operated, and/or managed through an application programming interface (API).

The host 534-1 can incorporate a hypervisor 536-1 that can execute a number of VCIs 538-1, 538-2, . . . , 538-N (referred to generally herein as “VCIs 538”). Likewise, the host 534-2 can incorporate a hypervisor 536-2 that can execute a number of VCIs 538. The hypervisor 536-1 and the hypervisor 536-2 are referred to generally herein as a hypervisor 536. The VCIs 538 can be provisioned with processing resources 540 and/or memory resources 542 and can communicate via the network interface 544. The processing resources 540 and the memory resources 542 provisioned to the VCIs 538 can be local and/or remote to the host 534. For example, in a software-defined data center, the VCIs 538 can be provisioned with resources that are generally available to the software-defined data center and not tied to any particular hardware device. By way of example, the memory resources 542 can include volatile and/or non-volatile memory available to the VCIs 538. The VCIs 538 can be moved to different hosts (not specifically illustrated), such that a different hypervisor manages (e.g., executes) the VCIs 538. The host 534 can be in communication with the session token routing system 546. In some embodiments, the session token routing system 546 can be deployed on a server, such as a web server. The session token routing system 546 can include computing resources (e.g., processing resources and/or memory resources in the form of hardware, circuitry, and/or logic, etc.) to perform various operations to route session tokens in the cluster 532.

A system in accordance with the present disclosure can include a database, a subsystem, and/or a number of engines, and can be in communication with the database via a communication link. The system can represent program instructions and/or hardware of a machine (e.g., a machine as referenced below, etc.). As used herein, an “engine” can include program instructions and/or hardware, but at least includes hardware. Hardware is a physical component of a machine that enables it to perform a function. Examples of hardware can include a processing resource, a memory resource, a logic gate, an application specific integrated circuit, a field programmable gate array, etc.

The number of engines can include a combination of hardware and program instructions that is configured to perform a number of functions described herein. The program instructions (e.g., software, firmware, etc.) can be stored in a memory resource (e.g., machine-readable medium) as well as hard-wired program (e.g., logic). Hard-wired program instructions (e.g., logic) can be considered as both program instructions and hardware.

A machine in accordance with the present disclosure can utilize software, hardware, firmware, and/or logic to perform a number of functions. The machine can be a combination of hardware and program instructions configured to perform a number of functions (e.g., actions). The hardware, for example, can include a number of processing resources and a number of memory resources, such as a machine-readable medium (MRM) or other memory resources. The memory resources can be internal and/or external to the machine (e.g., the machine can include internal memory resources and have access to external memory resources). In some embodiments, the machine can be a VCI. The program instructions (e.g., machine-readable instructions (MRI)) can include instructions stored on the MRM to implement a particular function (e.g., an action such as generating a session token, as described herein). The set of MRI can be executable by one or more of the processing resources. The memory resources can be coupled to the machine in a wired and/or wireless manner. For example, the memory resources can be an internal memory, a portable memory, a portable disk, and/or a memory associated with another resource, e.g., enabling MM to be transferred and/or executed across a network such as the Internet. As used herein, a “module” can include program instructions and/or hardware, but at least includes program instructions.

Memory resources can be non-transitory and can include volatile and/or non-volatile memory. Volatile memory can include memory that depends upon power to store information, such as various types of dynamic random access memory (DRAM) among others. Non-volatile memory can include memory that does not depend upon power to store information. Examples of non-volatile memory can include solid state media such as flash memory, electrically erasable programmable read-only memory (EEPROM), phase change memory (PCM), 3D cross-point, ferroelectric transistor random access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, magnetic memory, optical memory, and/or a solid state drive (SSD), etc., as well as other types of machine-readable media.

The processing resources can be coupled to the memory resources via a communication path. The communication path can be local or remote to the machine. Examples of a local communication path can include an electronic bus internal to a machine, where the memory resources are in communication with the processing resources via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof. The communication path can be such that the memory resources are remote from the processing resources, such as in a network connection between the memory resources and the processing resources. That is, the communication path can be a network connection. Examples of such a network connection can include a local area network (LAN), wide area network (WAN), personal area network (PAN), and the Internet, among others.

The MRI stored in the memory resources can be segmented into a number of modules that when executed by the processing resources can perform a number of functions. As used herein a module includes a set of instructions included to perform a particular task or action. The number of modules can be sub-modules of other modules. Furthermore, the number of modules can comprise individual modules separate and distinct from one another.

Each of the number of modules can include program instructions and/or a combination of hardware and program instructions that, when executed by a processing resource, can function as a corresponding engine as described above.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Various advantages of the present disclosure have been described herein, but embodiments may provide some, all, or none of such advantages, or may provide other advantages.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method, comprising:
generating a session token by a first node in a distributed extensible system responsive to a login to a user interface of the distributed extensible system loaded by the first node;
returning the session token to the user interface by the first node;
pushing the session token from the user interface to a plugin server configured to trust a second node of the distributed extensible system;
receiving a request at the second node to perform a particular action on the distributed extensible system, wherein the request is made by a plugin installed on the second node and includes the session token;
routing the request to the first node based on an identifier in the session token; and
performing the particular action on the distributed extensible system responsive to verifying the session token by the first node.

2. The method of claim 1, wherein generating the session token includes encoding the identifier in the session token.

3. The method of claim 1, wherein the method includes storing the session token by the first node before returning the session token to the user interface.

4. The method of claim 1, wherein the method includes:
configuring a first reverse proxy on the first node; and
configuring a second reverse proxy on the second node.

5. The method of claim 4, wherein the method includes configuring each of the first and second reverse proxies to route any plugin request to a node that issued a session token included in the plugin request.

6. The method of claim 1, wherein routing the request includes:
receiving the request by a reverse proxy of the second node; and
inspecting the session token for the identifier.

7. The method of claim 1, wherein the method includes receiving the request at the second node made by the plugin irrespective of a format of the session token.

8. The method of claim 1, wherein the method includes performing the particular action on the distributed extensible system responsive to verifying the session token by the first node against an authentication service of the first node.

9. A system, comprising:
a first node of a distributed extensible system;
a second node of the distributed extensible system, wherein the second node is configured to trust the first node, and wherein the first node is configured to trust the second node;
a user interface of the distributed extensible system;
a plugin installed on the second node and configured to trust the second node; and
a session token routing system, configured to:
receive a request at the second node, the request made from the user interface via the plugin, to perform a particular action on the distributed extensible system, wherein the request includes a session token previously issued by the first node;
route the request to the first node, using a reverse proxy on the second node, based on an indication in the session token that the session token was issued by the first node;
determine, using a reverse proxy on the first node, that the session token was issued by the first node;
distribute the request to a backend service corresponding to the particular action; and
perform the particular action by the backend service responsive to a verification of the session token against an authentication service of the first node.

10. The system of claim 9, including a plugin user interface configured to push the session token from the user interface to a plugin server configured to trust the second node.

11. The system of claim 9, wherein the backend service is on the first node.

12. The system of claim 9, wherein the reverse proxy on the first node is configured to route plugin requests received by the first node to respective nodes of the distributed extensible system that issued session tokens included in the plugin requests received by the first node.

13. The system of claim 9, wherein the reverse proxy on the second node is configured to route plugin requests received by the second node to respective nodes of the distributed extensible system that issued session tokens included in the plugin requests received by the second node.

14. The system of claim 9, wherein:
each of the first and second nodes is configured to issue session tokens; and
each of the first and second nodes is configured to maintain its respective state.

15. A non-transitory machine-readable medium having instructions stored thereon which, when executed by a processor, cause the processor to:
receive a request at a second node of a distributed extensible system to perform a particular action on the distributed extensible system, wherein the request is made from a user interface via a plugin installed on the second node that is configured to trust the second node, and wherein the request includes a session token previously issued by a first node of the distributed extensible system;
route the request to the first node, using a reverse proxy on the second node, based on an indication in the session token that the session token was issued by the first node;
determine, using a reverse proxy on the first node, that the session token was issued by the first node;
distribute the request to a backend service corresponding to the particular action; and
perform the particular action by the backend service responsive to a verification of the session token against an authentication service of the first node.

16. The medium of claim 15, wherein the plugin is not configured to trust the first node.

17. The medium of claim 15, wherein the indication in the session token that the session token was issued by the first node includes a name assigned to the first node.

18. The medium of claim 15, including instructions to issue the session token by the first node in a particular format.

19. The medium of claim 18, wherein the particular format includes:
the indication that the session token was issued by the first node; and
a unique value.

20. The medium of claim 15 including instructions to display the user interface as a web browser.
